(19) United States
(12) Patent Application Publication
(10) Pub. No.: US 2025/0324115 A1
(43) Pub. Date: Oct. 16, 2025

(54) METHODS AND SYSTEMS FOR CONTENT MANAGEMENT

(71) Applicant: Comcast Cable Communications, LLC, Philadelphia, PA (US)

(72) Inventors: Alexander Giladi, Centennial, CO (US); Ali Begen, Centennial, CO (US)

(21) Appl. No.: 18/631,490

(22) Filed: Apr. 10, 2024

(51) Int. Cl. H04N 21/2347

(52) U.S. Cl. CPC H04N 21/2347

(57) ABSTRACT

Methods, systems, and apparatus are described herein for determining and generating supplementary content such that a bitrate profile associated with underlying content is obfuscated.

### BACKGROUND

Privacy is a major concern for many consumers. If an eavesdropper has access to content that is being streamed by a user, the eavesdropper may be able to determine, for example based on a bitrate profile associated with the content, the identity of the content being sent to the user. Because the distribution over time of data sent to a user may have unique features such as bitrate peaks, eavesdroppers can implement content aware eavesdropping techniques to monitor the bitrate profile, match it to known bitrate profiles, and thereby determine what content a user is viewing.

### SUMMARY

Supplemental content may be added to requested content so as to obfuscate the bitrate profile associated with the requested content. For example, bitrate profile associated with the requested content may be used to determine how to add the supplemental content.

### BRIEF DESCRIPTION OF THE DRAWINGS

The accompanying drawings, which are incorporated in and constitute a part of this specification, illustrate embodiments and together with the description, serve to explain the principles: FIG. 1 is a block diagram of an example system and network;

FIGS. 2A-2B are block diagrams of exemplary bitrate profiles;

FIG. 3 is a flow chart of an example method;

FIG. 4 is a flow chart of an example method;

FIG. 5 is a flow chart of an example method;

FIG. 6 is a flow chart of an example method;

FIG. 7 is a flow chart of an example method;

FIG. 8 is a flow chart of an example method; and

FIG. 9 is a block diagram of an example computing device.

### DETAILED DESCRIPTION

Before the present content storing techniques are disclosed and described, it is to be understood that this disclosure is not limited to specific methods, specific components, or to particular implementations. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” or “example” means “an example of” and is not intended to convey an indication of a preferred or ideal embodiment. “Such as” is not used in a restrictive sense, but for explanatory purposes.

Disclosed are components that can be used to perform the disclosed content analysis and storage techniques. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present content analysis and storage techniques may be understood more readily by reference to the following detailed description of preferred embodiments and the examples included therein and to the Figures and their previous and following description.

As will be appreciated by one skilled in the art, the content analysis and storage techniques may take the form of an entirely hardware embodiment, an entirely software embodiment, or an embodiment combining software and hardware aspects. Furthermore, the content analysis and storage techniques may take the form of a computer program product on a computer-readable storage medium having computer-readable program instructions (e.g., computer software) embodied in the storage medium. More particularly, the present content analysis and storage techniques may take the form of web-implemented computer software. Any suitable computer-readable storage medium may be utilized including hard disks, CD-ROMs, optical storage devices, or magnetic storage devices.

Embodiments of the content analysis and storage techniques are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

FIG. 1 shows an example system 100 configured to carry out the present disclosure. One skilled in the art will appreciate that provided herein is a functional description and that the respective functions can be performed by software, hardware, or a combination of software and hardware. The system 100 may be configured to facilitate content distribution. The content may comprise any media such as video, music, television, an e-sports game, a traditional sporting event, a public address (for example, the State of the Union), a video clip, a television episode, a movie, streaming content, on-demand content, combinations thereof, and the like. The content may comprise one or more content segments (e.g., fragments, portions, packets, etc.).

The system 100 may comprise one or more computing devices 110, one or more edge devices 120, one or more user devices 130, and one or more networks 105. The various devices may be referred to in singular or plural form, and a person skilled in the art will appreciate that the system 100 is merely exemplary and may include any number of devices.

The computing device 110 may be configured to send, receive, store, analyze, and/or process content. For example, the computing device 110 may comprise a content server. The computing device 110 may comprise storage 116. The storage 116 may comprise any memory storage means as described herein. The storage 116 comprises computer readable media in the form of volatile memory, such as random access memory (RAM), and/or non-volatile memory, such as read only memory (ROM). The storage 116 may comprise permanent, semi-permanent, or non-permanent memory. The storage 116 may comprise a buffer. The storage 116 may be configured to store, send, receive, or otherwise process one or more content segments (e.g., content segments 117 and 118). In the course of sending/distributing content, the one or more content segments may be stored in the storage. The storage 116 may comprise a physical memory storage which may be used to store the one or more content segments. The storage 116 may be a device which is separate from the computing device 110. The one or more content segments may be stored automatically, or in response to an interruption event as described further herein.

The content (e.g., the one or more content segments) may be sent by/from the computing device 110 to the user device 130. For example, the one or more content segments may be sent directly to the user device through the network 105, or the one or more content segments may be routed through the edge device 120. The one or more content segments may be associated with the one or more data streams. For example, the one or more data streams may comprise the one or more content segments. A data stream of the one or more data streams may be output by the computing device 110. The data stream may comprise image data, video data, audio data, text data, metadata, supplemental data, combinations thereof, and the like associated with the content. For example, the video data may represent what a viewer may see on the display device, whether it be a movie, a game, or any other content.

Each of the video data and/or the metadata may comprise, among other things, timing information. The timing information may be used to synchronize supplemental data (e.g., one or more null packets, one or more supplemental data packets) with the video data.

The computing device 110 may comprise a communications module 119. The communications module 119 may be configured to send, receive, store, analyze, and/or otherwise process data sent/received to/from the network 105.

The computing device 110 may comprise an obfuscator 111. The obfuscator 111 may comprise a bitrate profile module 112, a packet module 113, and an information file module 114. The bitrate profile module 112 may be configured to determine one or more bitrate profiles associated with content (e.g., one or more content items, one or more content segments, the one or more data streams associated with content). The content may be requested content. The bitrate profile may comprise a representation of bits per unit time. The bitrate profile may represent a volume (e.g., quantity) of data packets sent per unit time. The data packets may comprise content carrying packets (e.g., one or more content packets). The data packets may comprise one or more null packets. The one or more null packets may comprise one or more packets with PID=0x1FFF (e.g., in MPEG-2 TS), one or more packets carrying stuffing bits (e.g., in MPEG-2 TS packet adaptation field), one or more free boxes (e.g., in ISO-BMFF), one or more user-defined SEI packets (e.g., with UUIDs and random bytes), one or more unspecified Video Coding Layer (VCL) packets, one or more Network Abstraction Layer (NAL) units with random bytes and optionally with encryption. For example, the latter two can be used with MPEG-2 TS, ISO-BMFF, RTP (as a result—any RTP-based protocol such as WebRTC or RTP over QUIC), or Media over QUIC.

A bitrate, often measured in bits per second (bps), represents the rate at which bits (e.g., data, binary digits) are transmitted or processed over a communication channel. The bitrate may indicate the speed or bandwidth of data transfer. The bitrate profile may comprise a dynamic representation of the bitrate over time, reflecting how the volume of data packets changes within specific intervals. Determining the bitrate profile may comprise monitoring and analyzing the flow of data packets over a network during a given timeframe. This process may include capturing and examining packet headers, payload sizes, transmission timestamps, combinations thereof, and the like. Various network analysis tools, protocols analyzers, or monitoring systems can be employed to measure and visualize the bitrate profile.

The bitrate profile module 112 may be configured to determine one or more enhanced bitrate profiles. The one or more enhanced bitrate profiles may be configured to obfuscate the bitrate profile (e.g., the original or underlying bitrate profile associated with the requested content). Thus, an eavesdropper with access to the data stream carrying the content, could not identify, based on the enhanced bitrate profile, the requested content. The enhanced bitrate profile may be determined based on the bitrate profile. Determining the enhanced bitrate profile may comprise determining timing information associated with one or more bitrate peaks and/or one or more bitrate troughs and determining, based on the timing information associated with the one or more bitrate peaks or one or more bitrate troughs, timing information associated with the one or more supplemental bitrate peaks or one or more supplemental bitrate troughs (e.g., one or more bitrate peaks or one or more bitrate troughs created by virtue of inserting data packets into the data stream and thereby changing the bitrate profile of the content sent to the requesting device).

The computing device 110 may comprise a packet module 113. The packet module 113 may be configured to insert, into the one or more data streams, according to the enhanced bitrate profile, one or more null packets, one more data packets, and/or one or more data bits. One or more null packets may be inserted into the stream to create artificial troughs. Inserting null packets, which contain no meaningful data, into an otherwise high data transmission can introduce periods of reduced bitrate in the stream (relative to nearby areas of the stream), leading to valleys (e.g., troughs) in the bitrate profile. For example, rather than sending two groups of one or more high data packets in a row, one or more null packets may be inserted between the two groups of one or more high data packets, and thereby create a bitrate trough. Various buffering schemes may be employed so as to not disrupt output of content by virtue of the presence of the one or more null packets.

Similarly, for example, additional data packets may be added to the stream. For example, packet stuffing involves adding extra bits or bytes to a packet, often to align with a particular format or to meet specific transmission requirements. This process can result in a sudden increase in the bitrate during the stuffed intervals, creating peaks in the bitrate profile. In either case, the enhanced bitrate profile may comprise additional bitrate peaks and bitrate troughs created by inserting the one or more null packets and/or additional data packets.

The packet module 113 may be configured to add the one or more null packets to the one or more data streams. For example, the packet module may be configured to insert one or more unregistered supplemental enhanced information (SEI) message (e.g., with a random UUID and randomized bytes) configured to be ignored (e.g., similar to a null packet) by a receiving device (e.g., the user device 130). For example, the computing device may be configured to insert user data in a way that avoids being interpreted as a filler message. User data may refer to any data provided or generated by a user within a system. It could be information, commands, or any other form of input. SEI may refer to Supplemental Enhancement Information, which may comprise additional data that can be included in a data stream. An unregistered SEI message suggests that this particular type of message is not formally defined or recognized within the system's protocol. UUID may comprise a “Universally Unique Identifier,” which is a standardized way of identifying information. A random UUID is a unique identifier generated in a random manner, typically using algorithms that ensure very low probability of collisions (e.g., two UUIDs being the same).

The computing device 110 may comprise an information file module 114. The information file module may be configured to determine (e.g., generate) one or more information files. One or more information files may be sent to the user device 130. For example, a single information file associated with the content may be sent, wherein the single information file comprises one or more null packet identifiers and null packet timing information associated with all of the null packets that will be inserted into a bitstream associated with the content. Additionally, and/or alternatively, a plurality of information files may be sent. For example, a first information file of the plurality of information files may comprise one or more null packet identifiers and/or null packet timing information associated with a first plurality of null packets inserted into the data stream associated with a first plurality of content segments associated with the content while a second information file may comprise one or more null packet identifier and/or null packet timing information associated with a second plurality of null packets inserted to the data stream associated with a second plurality of content segments of the content. For example, secondary content (e.g., an advertisement) may be received by the media device and output after the first plurality of content segments and before the second plurality of content segments.

The one or more information files may be configured to cause the media device to not output (e.g., ignore, remove from a buffer), the one or more null packets. The enhanced bitrate profile may be configured to obfuscate the bitrate profile (e.g., the original bitrate profile associated with the requested content). Thus, an eavesdropper with access to the data stream carrying the content, could not identify, based on the enhanced bitrate profile, the requested content.

The edge device 120 may comprise a bitrate profile module 121, a packet module 122, and an information file module 123. The bitrate profile module 121 may be configured to determine one or more bitrate profiles associated with one or more content items. Determining the bitrate profile may comprise monitoring and analyzing the flow of data packets over a network during a given timeframe. This process may include capturing and examining packet headers, payload sizes, transmission timestamps, combinations thereof, and the like. Various network analysis tools, protocols analyzers, or monitoring systems can be employed to measure and visualize the bitrate profile.

The bitrate profile module 121 may be configured to determine one or more enhanced bitrate profiles. The one or more enhanced bitrate profiles may be configured to obfuscate the bitrate profile (e.g., the original bitrate profile associated with the requested content). Thus, an eavesdropper with access to the data stream carrying the content, could not identify, based on the enhanced bitrate profile, the requested content. The one or more enhanced bitrate profiles may be determined based on the bitrate profile. Determining the enhanced bitrate profile may comprise determining timing information associated with the one or more bitrate peaks and determining, based on the timing information associated with the one or more bitrate peaks, timing information associated with the one or more bitrate troughs.

The edge device 120 may comprise a packet module 122. The packet module 122 may be configured to insert, into a data stream, according to the enhanced bitrate profile, one or more null packets, one more data packets, and/or one or more data bits. One or more null packets may be inserted into the stream to create artificial troughs. Inserting null packets, which contain no meaningful data, can introduce periods of reduced bitrate in the stream, leading to valleys (e.g., troughs) in the bitrate profile.

Similarly, for example, additional data packets may be added to the stream. For example, packet stuffing involves adding extra bits or bytes to a packet, often to align it with a particular format or to meet specific transmission requirements. This process can result in a sudden increase in the bitrate during the stuffed intervals, creating peaks in the bitrate profile. In either case, the enhanced bitrate profile may comprise additional bitrate peaks and bitrate troughs created by inserting the one or more null packets and/or additional data packets.

The edge device 120 may comprise an information file module 123. The information file module may be configured to determine (e.g., generate) one or more information files. One or more information files may be sent to the media device. For example, a single information file associated with the content may be sent, wherein the single information file comprises one or more null packet identifiers and null packet timing information associated with all of the null packets that will be inserted into a bitstream associated with the content. Additionally, and/or alternatively, a plurality of information files may be sent. For example, a first information file of the plurality of information files may comprise one or more null packet identifiers and/or null packet timing information associated with a first plurality of null packets inserted into the data stream associated with a first plurality of content segments associated with the content while a second information file may comprise one or more null packet identifier and/or null packet timing information associated with a second plurality of null packets inserted to the data stream associated with a second plurality of content segments of the content. For example, secondary content (e.g., an advertisement) may be received by the media device and output after the first plurality of content segments and before the second plurality of content segments.

The one or more information files may be configured to cause the media device to not output (e.g., ignore, remove from a buffer), the one or more null packets. The enhanced bitrate profile may be configured to obfuscate the bitrate profile (e.g., the original bitrate profile associated with the requested content). Thus, an eavesdropper with access to the data stream carrying the content, could not identify, based on the enhanced bitrate profile, the requested content.

The user device 130 may comprise a media device (e.g., a set-top-box), a smart phone, a computer, a smart tv, combinations thereof, and the like. The media device may be a digital streaming device, a gaming device, a media storage device, a digital recording device, a computing device, a mobile computing device (e.g., a laptop, a smartphone, a tablet, etc.), combinations thereof, and the like.

The media device may comprise a demodulator, decoder, frequency tuner, combinations thereof, and the like. The media device may be directly connected to the network (e.g., for communications via in-band and/or out-of-band signals of a content delivery network) and/or connected to the network via a communication terminal (e.g., for communications via a packet switched network). The media device may implement one or more applications, such as content viewers, social media applications, news applications, gaming applications, content stores, electronic program guides, combinations thereof, and the like. Those skilled in the art will appreciate that the signal may be demodulated and/or decoded in a variety of equipment, including the communication terminal, a computer, a TV, a monitor, or a satellite dish. The communication terminal may be located at the user location. The communication terminal may be configured to communicate with the network. The communication terminal may be a modem (e.g., cable modem), a router, a gateway, a switch, a network terminal (e.g., optical network unit), combinations thereof, and the like. The communication terminal may be configured for communication with the network via a variety of protocols, such as IP, transmission control protocol, file transfer protocol, session initiation protocol, voice over IP (e.g., VOIP), combinations thereof, and the like. The communication terminal, for a cable network, may be configured to facilitate network access via a variety of communication protocols and standards, such as Data Over Cable Service Interface Specification (DOCSIS).

The user device 130 may comprise a communications module 131. The communications module 131 may be configured to send, receive, store, analyze, and/or otherwise process data sent/received to/from the network 105.

The user device 130 may comprise storage 132. The storage 132 may comprise any memory storage means as described herein. The storage 132 comprises computer readable media in the form of volatile memory, such as random access memory (RAM), and/or non-volatile memory, such as read only memory (ROM). The storage 132 may comprise permanent, semi-permanent, or non-permanent memory. The storage 132 may comprise a buffer. The storage 132 may be configured to store, send, receive, or otherwise process one or more content segments (e.g., content segments 117 and 118).

Referring back to components of the system 100, the network 105 may comprise any telecommunications network such as the Internet or a local area network. Other forms of communications can be used such as wired or wireless telecommunication channels, for example. The network 105 may be an optical fiber network, a coaxial cable network, a hybrid fiber-coaxial network, a wireless network, a satellite system, a direct broadcast system, an Ethernet network, a high-definition multimedia interface network, a Universal Serial Bus (USB) network, or any combination thereof. As a particular example, the network 105 can comprise a cellular network. One of skill in the art will appreciate that the computing device 104 may be any server suitable for processing content.

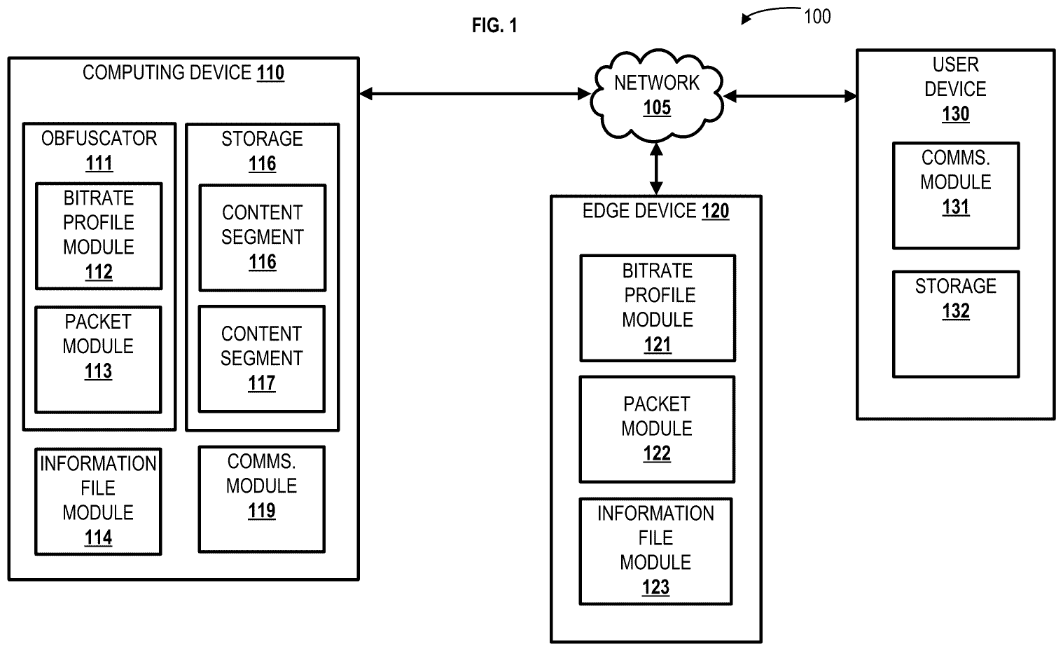

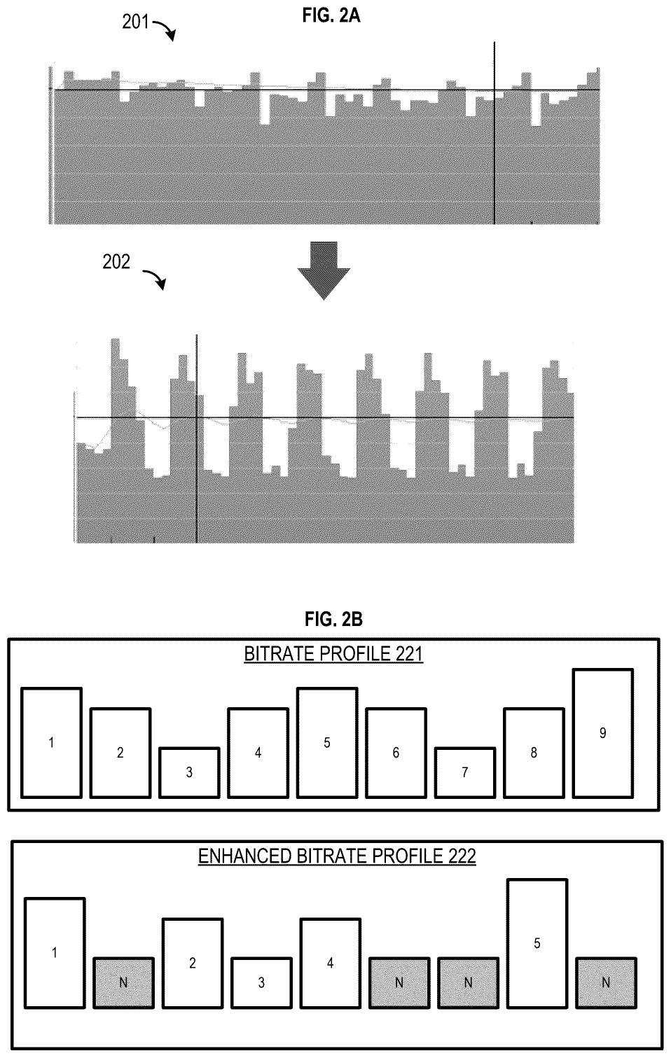

FIG. 2A shows a bitrate profile 211 and an enhanced bitrate profile 212. The bitrate profile 211 may be associated with content. The content may be requested content. A bitrate profile associated with content may be determined. The bitrate profile may comprise a representation of bits per unit time. The bitrate profile may represent a volume (e.g., quantity) of data packets sent per unit time. The data packets may comprise content carrying packets (e.g., one or more content packets). The data packets may comprise one or more null packets. A bitrate, often measured in bits per second (bps), represents the rate at which bits (binary digits) are transmitted or processed over a communication channel. The bitrate may indicate the speed or bandwidth of data transfer. The bitrate profile may comprise a dynamic representation of the bitrate over time, reflecting how the volume of data packets changes within specific intervals. Determining the bitrate profile may comprise monitoring and analyzing the flow of data packets over a network during a given timeframe. This process may include capturing and examining packet headers, payload sizes, transmission timestamps, combinations thereof, and the like. Various network analysis tools, protocols analyzers, or monitoring systems can be employed to measure and visualize the bitrate profile.

The enhanced bitrate profile 212, may be configured to obfuscate the bitrate profile (e.g., the original bitrate profile associated with the requested content). Thus, an eavesdropper with access to the data stream carrying the content, could not identify, based on the enhanced bitrate profile, the requested content. The enhanced bitrate profile may be determined based on the bitrate profile. Determining the enhanced bitrate profile may comprise determining timing information associated with the one or more bitrate peaks and determining, based on the timing information associated with the one or more bitrate peaks, timing information associated with the one or more bitrate troughs.

One or more null packets may be inserted into the stream to create artificial troughs. Inserting null packets, which contain no meaningful data, can introduce periods of reduced bitrate in the stream, leading to valleys (e.g., troughs) in the bitrate profile.

Similarly, for example, additional data packets may be added to the stream. For example, packet stuffing involves adding extra bits or bytes to a packet, often to align it with a particular format or to meet specific transmission requirements. This process can result in a sudden increase in the bitrate during the stuffed intervals, creating peaks in the bitrate profile. In either case, the enhanced bitrate profile 212 may comprise additional bitrate peaks and bitrate troughs created by inserting the one or more null packets and/or additional data packets.

FIG. 2B shows an example bitrate profile 221 and an example enhanced bitrate profile 222. The bitrate profile 221 shows 9 packet sample instances where time is on the x-axis and data volume (e.g., bitrate, packet volume) is on the y-axis. Instances 1 and 2 form a first bitrate peak, instances 4-6 form a second bitrate peak, and instance 8 forms a third bitrate peak. Enhanced bitrate profile 222 shows one or more null packets (marked with “N”) inserted between content carrying packets. By inserting the one or more null packets and creating bitrate troughs, the bitrate profile of the underlying content is obfuscated from an eavesdropper.

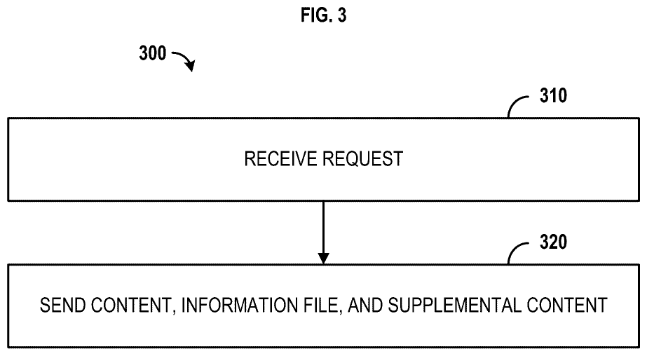

FIG. 3 shows an example method 300. The method may be carried out via any one or more devices as described herein. For example, at 310, a request for content may be received. The data profile may be determined based on a request for content. For example, the request for content may be sent by a media device. The media device may comprise, for example, a set-top-box (STB), a smartphone, smart television, or other similar device. The request for content may be sent to a computing device. For example, the computing device may comprise a content server. For example, the media device may send the request for content to a content server. The request may comprise one or more identifiers. For example, the request may comprise a media device identifier associated with the media device. For example, the request may comprise a content identifier associated with the content. For example, the request may comprise a bitrate indicator associated with a desired bitrate. For example, the request may comprise a request for supplemental content.

A data profile may be determined. The data profile may comprise a bitrate profile. Determining the data profile may comprise determining the bitrate profile. The data profile may comprise a representation of bits per unit time. The data profile may represent a volume (e.g., quantity) of data packets sent per unit time. The data packets may comprise content carrying packets (e.g., one or more content packets). The data packets may comprise one or more null packets. The one or more null packets may comprise one or more packets with PID=0x1FFF (e.g., in MPEG-2 TS), one or more packets carrying stuffing bits (e.g., in MPEG-2 TS packet adaptation field), one or more free boxes (e.g., in ISO-BMFF), one or more user-defined SEI packets (e.g., with UUIDs and random bytes), one or more unspecified Video Coding Layer (VCL) packets, one or more Network Abstraction Layer (NAL) units with random bytes and optionally with encryption. For example, the latter two can be used with MPEG-2 TS, ISO-BMFF, RTP (as a result—any RTP-based protocol such as WebRTC or RTP over QUIC), or Media over QUIC.

The bitrate profile may comprise a dynamic representation of the bitrate over time, reflecting how the volume of data packets changes within specific intervals. Determining the bitrate profile may comprise monitoring and analyzing the flow of data packets over a network during a given timeframe. This process may include capturing and examining packet headers, payload sizes, transmission timestamps, combinations thereof, and the like. Various network analysis tools, protocols analyzers, or monitoring systems can be employed to measure and visualize the bitrate profile.

At 320, the content may be sent to the media device. The content may be sent to the media device based on the request. Additionally, and/or alternatively, supplemental content may be sent to the media device. The supplemental content may be sent to the media device based on the request. The supplemental content may comprise one or more null packets. The one or more null packets may comprise a type of data packet that contains no meaningful information or payload. For example, the one or more null packets may comprise header information and a minimal amount of data, if any. For example, the one or more null packets may lack content that would be present in a data packet configured to carry content. By introducing null packets, the overall bitrate profile (e.g., bitrate) may be configured to prevent and/or induce one or more bitrate spikes or bitrate drops (e.g., drop in bitrate).

One or more information files may be sent to the media device. For example, a single information file associated with the content may be sent, wherein the single information file comprises one or more null packet identifiers and null packet timing information associated with all of the null packets that will be inserted into a bitstream associated with the content. Additionally, and/or alternatively, a plurality of information files may be sent. For example, a first information file of the plurality of information files may comprise one or more null packet identifiers and/or null packet timing information associated with a first plurality of null packets inserted into the data stream associated with a first plurality of content segments associated with the content while a second information file may comprise one or more null packet identifier and/or null packet timing information associated with a second plurality of null packets inserted to the data stream associated with a second plurality of content segments of the content. For example, secondary content (e.g., an advertisement) may be received by the media device and output after the first plurality of content segments and before the second plurality of content segments.

The one or more information files may be configured to cause the media device to not output (e.g., ignore, remove from a buffer), the one or more null packets. The enhanced bitrate profile may be configured to obfuscate the bitrate profile (e.g., the original bitrate profile associated with the requested content). Thus, an eavesdropper with access to the data stream carrying the content, could not identify, based on the enhanced bitrate profile, the requested content.

The method may comprise determining, based on a random number and a bitrate profile associated with the content, an amount of the supplemental content to send to the media device. The method may comprise determining, based on a variable bitrate encoding scheme, one or more bitrate peaks. The method may comprise generating, via one or more null packets, one or more bitrate troughs. For example, the one or more bitrate troughs may be generated by inserting one or more null packets into the stream at the time associated with the one or more bitrate peaks.

The method may comprise determining a bit profile associated with content. The method may comprise determining, based on the bit profile, one or more bit peaks. The method may comprise determining, based on the one or more bit peaks, one or more bit troughs. The method may comprise determining, based on the one or more bit peaks and the one or more bit troughs, an enhanced bit profile. The method may comprise generating, based on the enhanced bit profile, supplemental content and an information file associated with the content. The method may comprise sending, to a media device, the content, the supplemental content, and the information file.

The method may comprise receiving, from a content source, based on a request for content from a media device, content. The method may comprise determining, based on the content, a bit profile associated with the content. The method may comprise determining, based on the bit profile associated with the content, an enhanced bit profile associated with supplemental content and an information file associated with the supplemental content. The method may comprise sending, to the media device, based on the enhanced bit profile, the content, the supplemental content, and the information file.

The method may comprise sending, by a media device, a request for content. The method may comprise receiving, from a computing device, based on the request, the content, supplemental content, and an information file, wherein the information file is configured to cause the media device to identify the supplemental content.

The method may comprise determining, based on a request for content, a first bit profile associated with a first plurality of content segments of the content and a second bit profile associated with a second plurality of content segments of the content. The method may comprise determining, based on the first bit profile associated with the first plurality of content segments, a first enhanced bit profile associated with the first plurality of content segments. The method may comprise determining, based on the second bit profile associated with the second plurality of content segments, a second enhanced bit profile associated with the second plurality of content segments. The method may comprise generating, based on the first enhanced bit profile associated with the first plurality of content segments, a first information file. The method may comprise generating, based on the second enhanced bit profile associated with the second plurality of content segments, a second information file. The method may comprise sending, to the media device, the first information file. The method may comprise sending, to the media device the second information file.

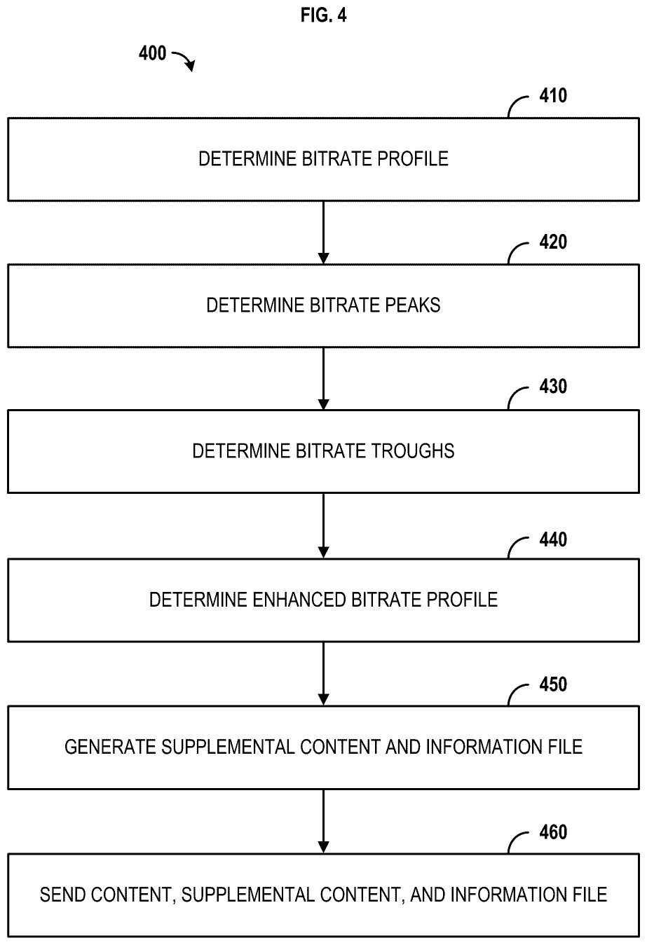

FIG. 4 shows an example method 400. The method may be carried out via any one or more devices as described herein. At 410, a data profile associated with content may be determined. The data profile may comprise a representation of bitrate distribution over time, calculated per unit of time. The data profile may represent a volume (e.g., quantity) of data packets sent per unit time. The data packets may comprise content carrying packets (e.g., one or more content packets). The data packets may comprise one or more null packets. A bitrate, often measured in bits per second (bps), represents the rate at which bits (binary digits) are transmitted or processed over a communication channel. The bitrate may indicate the speed or bandwidth of data transfer. A data profile may comprise a dynamic representation of the bitrate over time, reflecting how the volume of data packets changes within specific intervals. Determining the data profile may comprise monitoring and analyzing the flow of data packets over a network during a given timeframe. This process may include capturing and examining packet headers, payload sizes, transmission timestamps, combinations thereof, and the like. Various network analysis tools, protocols analyzers, or monitoring systems can be employed to measure and visualize the data profile.

At 420, one or more data peaks may be determined. The one or more data peaks may comprise one or more instances of high packet volume (e.g., a high number of packets per unit time and/or one or more packets with large content payloads such as those that carry high-definition action content).

At 430, one or more data troughs may be determined. The one or more data troughs may be determined based on the data peaks. The one or more data troughs may be determined based on timing data associated with the one or more data peaks. For example, the one or more data troughs may be determined so as to occur during the one or more data peaks.

At 440, an enhanced data profile may be determined. The enhanced data profile may comprise the one or more data troughs. The enhanced data profile may be configured to obfuscate the underlying data profile associated with the content. Determining the enhanced data profile may comprise determining timing information associated with the one or more data peaks and determining, based on the timing information associated with the one or more data peaks, timing information associated with the one or more data troughs.

At 450, supplemental content and an information file may be generated. The supplemental content may comprise one or more null packets. The supplementary content may be inserted into the data stream to conform to the enhanced data profile, thereby obfuscating the (underlying) data profile associated with the content. For example, the information file may comprise one or more null packet identifiers and null packet timing information associated with the one or more null packets inserted into the content steam. The information file may be configured to cause the media device to not process the supplemental content. Not processing the supplemental content may comprise not storing the supplemental content, removing the supplemental content from storage, not outputting the supplemental content, combinations thereof, and the like.

At 460, the content, supplemental content (e.g., one or more null packets), and the information file may be sent. For example, the content, supplemental content, and the information file may be sent to the media device.

The method may comprise inserting, into a data stream associated with the content, supplemental content. The method may comprise receiving, from the media device, a request for both the content and supplemental content. For example, the request may be configured to cause a computing device to insert, based on the request for the content, a random amount of supplemental content into a data stream associated with the content. The method may comprise determining, based on the content, an amount of supplemental content to insert into a data stream comprising the content.

The method may comprise appending a random number of bytes to each transmitted segment. The method may comprise a CDN generating a random number following some statistical distribution fitting natural video. For example, this number can be generated by the CDN edge as a part of processing an incoming HTTP GET request, or can be generated by the client and passed to the CDN (e.g., using a URL query parameter). As a response, the CDN may add fillers (e.g., filler NAL units, NULL packets (for MPEG-2 TS), ‘free’ ISO-BMFF boxes) to the requested segment.

In case of video on demand sessions, it is possible to achieve a similar effect without an additional bandwidth overhead. For example, the method may comprise the client requesting a random number of bytes from other (sub) segments or full subsegments, either from the same type of content (e.g., video) or from a different type (e.g., audio). The randomization may be determined by the CDN edge or requested by the client.

The method may comprise filling the client buffer to some high watermark and causing the media device to start requesting segments or byte ranges of a segment at randomized times so as to introduce random long pauses in requests and request bursts.

The method may comprise indicating that all media traffic is incremental (from the HTTP/3 priority definition standpoint), in which case packets with responses for video and audio segment requests may be transmitted in an interleaved manner.

The method may comprise receiving, from a media device, a request for content. The method may comprise sending, to the media device, based on the request, the content, supplemental content, and one or more information files, wherein the information file are configured to cause the media device to identify the supplemental content.

The method may comprise receiving, from a content source, based on a request for content from a media device, content. The method may comprise determining, based on the content, a bit profile associated with the content. The method may comprise determining, based on the bit profile associated with the content, an enhanced bit profile associated with supplemental content and an information file associated with the supplemental content. The method may comprise sending, to the media device, based on the enhanced bit profile, the content, the supplemental content, and the information file.

The method may comprise sending, by a media device, a request for content. The method may comprise receiving, from a computing device, based on the request, the content, supplemental content, and an information file, wherein the information file is configured to cause the media device to identify the supplemental content.

The method may comprise determining, based on a request for content, a first bit profile associated with a first plurality of content segments of the content and a second bit profile associated with a second plurality of content segments of the content. The method may comprise determining, based on the first bit profile associated with the first plurality of content segments, a first enhanced bit profile associated with the first plurality of content segments. The method may comprise determining, based on the second bit profile associated with the second plurality of content segments, a second enhanced bit profile associated with the second plurality of content segments. The method may comprise generating, based on the first enhanced bit profile associated with the first plurality of content segments, a first information file. The method may comprise generating, based on the second enhanced bit profile associated with the second plurality of content segments, a second information file. The method may comprise sending, to the media device, the first information file. The method may comprise sending, to the media device the second information file.

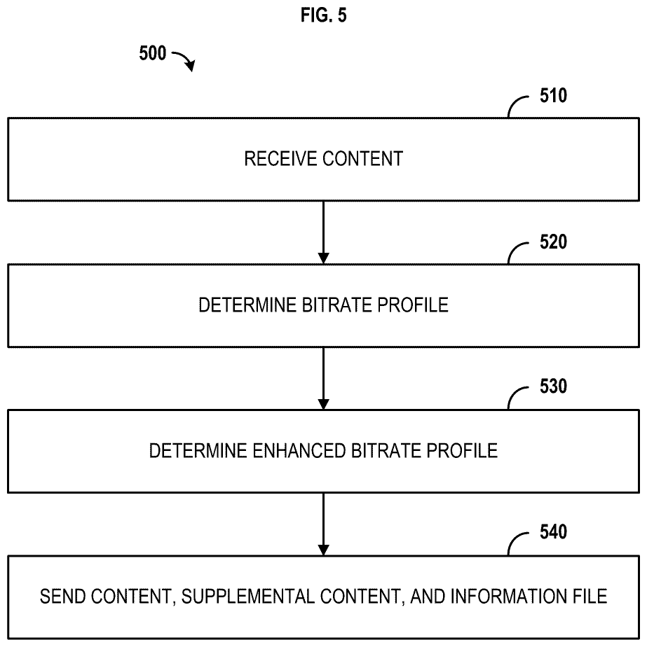

FIG. 5 shows an example method 500. The method may be carried out via any one or more devices as described herein. At 510, content may be received. The content may be received, for example, from a content source (e.g., a content server). The content may be received, for example, by an edge device. The edge device may be a server, network node, or other device located between an origin server (e.g., a content server) and a terminal device (e.g., the media device). The received content may be bound for the media device. For example, and edge device can be co-located with a virtual cable modem termination system (CMTS).

At 520, a data profile associated with the content may be determined. The data profile may comprise a representation of bits per unit time. The data profile may represent a volume (e.g., quantity) of data packets sent per unit time. The data packets may comprise content carrying packets (e.g., one or more content packets). The data packets may comprise one or more null packets. A bitrate, often measured in bits per second (bps), represents the rate at which bits (binary digits) are transmitted or processed over a communication channel. The bitrate may indicate the speed or bandwidth of data transfer. A data profile may comprise a dynamic representation of the bitrate over time, reflecting how the volume of data packets changes within specific intervals. Determining the data profile may comprise monitoring and analyzing the flow of data packets over a network during a given timeframe. This process may include capturing and examining packet headers, payload sizes, transmission timestamps, combinations thereof, and the like. Various network analysis tools, protocols analyzers, or monitoring systems can be employed to measure and visualize the data profile.

At 530, an enhanced data profile may be determined. The enhanced data profile may be configured to obfuscate the data profile (e.g., the original data profile associated with the requested content). Thus, an eavesdropper with access to the data stream carrying the content, could not identify, based on the enhanced data profile, the requested content. The enhanced data profile may comprise the one or more additional bitrate peaks. Determining the enhanced data profile may comprise determining timing information associated with the one or more bitrate peaks and determining, based on the timing information associated with the one or more bitrate peaks, timing information associated with the one or more bitrate troughs.

Also at 530, an information file may be determined. For example, the information file may comprise one or more null packet identifiers and null packet timing information associated with the one or more null packets inserted into the content steam. The information file may be configured to cause the media device to not process the supplemental content. Not processing the supplemental content may comprise not storing the supplemental content, removing the supplemental content from storage, not outputting the supplemental content, combinations thereof, and the like.

At 540, the content and the information file may be sent to the media device. The supplemental content may be sent to the media device as well. For example, the supplemental content may be sent to the media device based on the enhanced data profile.

The method may comprise inserting, into a data stream associated with the content, supplemental content. The method may comprise receiving, from the media device, a request for both the content and supplemental content. For example, the request may be configured to cause a computing device to insert, based on the request for the content, a random amount of supplemental content into a data stream associated with the content. The method may comprise determining, based on the content, an amount of supplemental content to insert into a data stream comprising the content.

The method may comprise appending a random number of bytes to each transmitted segment. The method may comprise a CDN generating a random number following some statistical distribution fitting natural video. For example, this number can be generated by the CDN edge as a part of processing an incoming HTTP GET request, or can be generated by the client and passed to the CDN (e.g., using a URL query parameter). As a response, the CDN may add fillers (e.g., filler NAL units, NULL packets (for MPEG-2 TS), ‘free’ ISO-BMFF boxes) to the requested segment.

In case of video on demand sessions, it is possible to achieve a similar effect without an additional bandwidth overhead. For example, the method may comprise the client requesting a random number of bytes from other (sub) segments or full subsegments, either from the same type of content (e.g., video) or from a different type (e.g., audio). The randomization may be determined by the CDN edge or requested by the client.

The method may comprise filling the client buffer to some high watermark and causing the media device to start requesting segments or byte ranges of a segment at randomized times so as to introduce random long pauses in requests and request bursts.

The method may comprise indicating that all media traffic is incremental (from the HTTP/3 priority definition standpoint), in which case packets with responses for video and audio segment requests may be transmitted in an interleaved manner.

The method may comprise receiving, from a media device, a request for content. The method may comprise sending, to the media device, based on the request, the content, supplemental content, and one or more information files, wherein the information file are configured to cause the media device to identify the supplemental content.

The method may comprise determining a bit profile associated with content. The method may comprise determining, based on the bit profile, one or more bit peaks. The method may comprise determining, based on the one or more bit peaks, one or more bit troughs. The method may comprise determining, based on the one or more bit peaks and the one or more bit troughs, an enhanced bit profile. The method may comprise generating, based on the enhanced bit profile, supplemental content and an information file associated with the content. The method may comprise sending, to a media device, the content, the supplemental content, and the information file.

The method may comprise sending, by a media device, a request for content.

The method may comprise receiving, from a computing device, based on the request, the content, supplemental content, and an information file, wherein the information file is configured to cause the media device to identify the supplemental content.

The method may comprise determining, based on a request for content, a first bit profile associated with a first plurality of content segments of the content and a second bit profile associated with a second plurality of content segments of the content. The method may comprise determining, based on the first bit profile associated with the first plurality of content segments, a first enhanced bit profile associated with the first plurality of content segments. The method may comprise determining, based on the second bit profile associated with the second plurality of content segments, a second enhanced bit profile associated with the second plurality of content segments. The method may comprise generating, based on the first enhanced bit profile associated with the first plurality of content segments, a first information file. The method may comprise generating, based on the second enhanced bit profile associated with the second plurality of content segments, a second information file. The method may comprise sending, to the media device, the first information file. The method may comprise sending, to the media device the second information file.

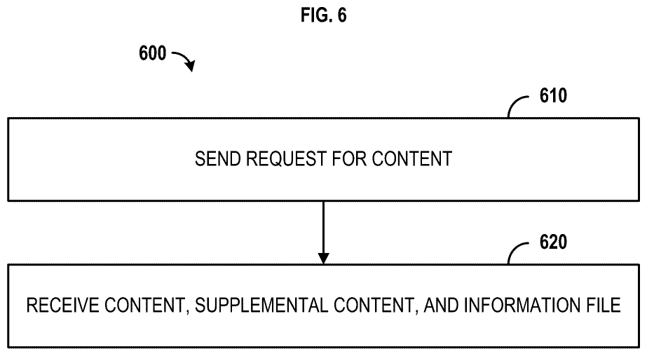

FIG. 6 shows an example method 600. The method may be carried out by any one or more devices as described herein. For example, at 610, a request for content may be sent. For example, the request for content may be sent by the media device. For example, the media device may send the request for content to a content device (e.g., a content server). The request may comprise one or more identifiers. For example, the request may comprise a media device identifier associated with the media device. For example, the request may comprise a user identifier associated with a user of the media device. For example, the request may comprise a content identifier associated with content. For example, the request may comprise one or more bitrate profile identifiers. The one or more bitrate profile identifiers may indicate one or more configuration parameters associated with the media device and/or a network or network devices associated with the media device. For example, the request may comprise a service level identifier, a quality of service (QoS) identifier, subscription identifier, combinations thereof, and the like. The content may be associated with a data profile.

At 620, the content may be received by the media device. The content may be received by the media device based on the request. Additionally, and/or alternatively, supplemental content may be received by the media device. The supplemental content may be received by the media device based on the request. The supplemental content may comprise one or more null packets. The one or more null packets may comprise a type of data packet that contains no meaningful information or payload. For example, the one or more null packets may comprise header information and a minimal amount of data, if any. For example, the one or more null packets may lack content that would be present in a data packet configured to carry content. By introducing null packets, the overall bitrate profile (e.g., bitrate) may be configured to prevent and/or induce one or more bitrate spikes or bitrate drops (e.g., drop in bitrate).

One or more information files may be received by the media device. For example, a single information file associated with the content may be sent, wherein the single information file comprises one or more null packet identifiers and null packet timing information associated with all of the null packets that will be inserted into a bitstream associated with the content. Additionally, and/or alternatively, a plurality of information files may be received. For example, a first information file of the plurality of information files may comprise one or more null packet identifiers and/or null packet timing information associated with a first plurality of null packets inserted into the data stream associated with a first plurality of content segments associated with the content while a second information file may comprise one or more null packet identifier and/or null packet timing information associated with a second plurality of null packets inserted to the data stream associated with a second plurality of content segments of the content. For example, secondary content (e.g., an advertisement) may be received by the media device and output after the first plurality of content segments and before the second plurality of content segments.

The one or more information files may be configured to cause the media device to not output (e.g., ignore, remove from a buffer), the one or more null packets. The enhanced bitrate profile may be configured to obfuscate the bitrate profile (e.g., the original bitrate profile associated with the requested content). Thus, an eavesdropper with access to the data stream carrying the content, could not identify, based on the enhanced bitrate profile, the requested content.

At 630, the content and supplemental content may be processed. For example, the content and supplemental content may be processed by the media device. The content and supplemental content may be processed according to (e.g., in accordance with) the information file. For example, the information file may indicate one or more processing actions to be taken with respect to the content and/or the supplemental content. For example, the information file may comprise one or more storage actions associated with the content and/or supplemental content and/or one or more output actions associated with the content and/or supplemental content. For example, the information file may be configured to cause the media device to selectively store the content and/or the supplemental content. For example, the information file may be configured to cause the media device to selectively output the content and/or the supplemental content.

The method may comprise storing the content. The method may comprise storing the supplemental content. The method may comprise receiving secondary content. The secondary content may comprise one or more advertisements. The secondary content may comprise one or more supplemental features (e.g., metadata, applications, additional functionalities, etc.). The method may comprise outputting the content. The method may comprise not outputting the supplemental content. The method may comprise removing the supplemental content from storage (e.g., removing or “dropping” the supplemental content from a buffer).

The method may comprise appending a random number of bytes to each transmitted segment. The method may comprise a CDN generating a random number following some statistical distribution fitting natural video. For example, this number can be generated by the CDN edge as a part of processing an incoming HTTP GET request, or can be generated by the client and passed to the CDN (e.g., using a URL query parameter). As a response, the CDN may add fillers (e.g., filler NAL units, NULL packets (for MPEG-2 TS), ‘free’ ISO-BMFF boxes) to the requested segment.

In case of video on demand sessions, it is possible to achieve a similar effect without an additional bandwidth overhead. For example, the method may comprise the client requesting a random number of bytes from other (sub) segments or full subsegments, either from the same type of content (e.g., video) or from a different type (e.g., audio). The randomization may be determined by the CDN edge or requested by the client.

The method may comprise filling the client buffer to some high watermark and causing the media device to start requesting segments or byte ranges of a segment at randomized times so as to introduce random long pauses in requests and request bursts.

The method may comprise indicating that all media traffic is incremental (from the HTTP/3 priority definition standpoint), in which case packets with responses for video and audio segment requests may be transmitted in an interleaved manner.

The method may comprise receiving, from a media device, a request for content. The method may comprise sending, to the media device, based on the request, the content, supplemental content, and one or more information files, wherein the information file are configured to cause the media device to identify the supplemental content.

The method may comprise determining a bit profile associated with content. The method may comprise determining, based on the bit profile, one or more bit peaks. The method may comprise determining, based on the one or more bit peaks, one or more bit troughs. The method may comprise determining, based on the one or more bit peaks and the one or more bit troughs, an enhanced bit profile. The method may comprise generating, based on the enhanced bit profile, supplemental content and an information file associated with the content. The method may comprise sending, to a media device, the content, the supplemental content, and the information file.

The method may comprise receiving, from a content source, based on a request for content from a media device, content. The method may comprise determining, based on the content, a bit profile associated with the content. The method may comprise determining, based on the bit profile associated with the content, an enhanced bit profile associated with supplemental content and an information file associated with the supplemental content. The method may comprise sending, to the media device, based on the enhanced bit profile, the content, the supplemental content, and the information file.

The method may comprise determining, based on a request for content, a first bit profile associated with a first plurality of content segments of the content and a second bit profile associated with a second plurality of content segments of the content. The method may comprise determining, based on the first bit profile associated with the first plurality of content segments, a first enhanced bit profile associated with the first plurality of content segments. The method may comprise determining, based on the second bit profile associated with the second plurality of content segments, a second enhanced bit profile associated with the second plurality of content segments. The method may comprise generating, based on the first enhanced bit profile associated with the first plurality of content segments, a first information file. The method may comprise generating, based on the second enhanced bit profile associated with the second plurality of content segments, a second information file. The method may comprise sending, to the media device, the first information file. The method may comprise sending, to the media device the second information file.

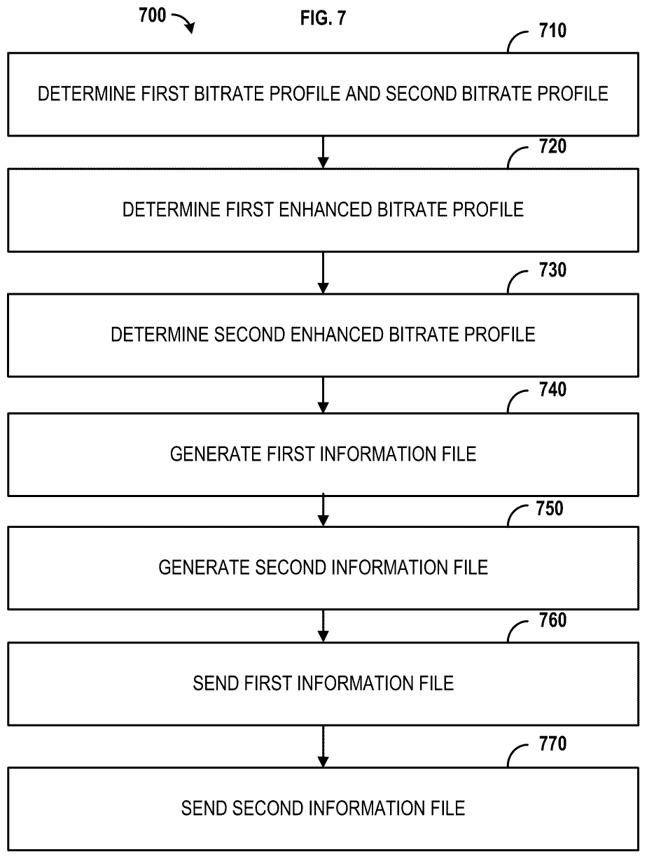

FIG. 7 shows an example method 700. The method may be carried out by any one or more devices as described herein. At 710, a first data profile associated with a first plurality of content segments and a second data profile associated with a second plurality of content segments may be determined. The first plurality of content segments may comprise a first length of content (e.g., five minutes of content). The second plurality of content segments may comprise a second length of content (e.g., five minutes of content). The first data profile may comprise a representation of bits per unit time. The first data profile may represent a volume (e.g., quantity) of data packets sent per unit time. The data packets may comprise content carrying packets. The second data profile may comprise a representation of bits per unit time. The second data profile may represent a volume (e.g., quantity) of data packets sent and/or received per unit time. The data packets may comprise content carrying packets.

At 720, a first enhanced data profile may be determined. The first enhanced data profile may be associated with the first plurality of content segments. The first enhanced data profile may comprise a representation of bits per unit time associated a first enhanced data stream. The first enhanced data stream may comprise the one or more content packets and one or more null packets.

At 730, a second enhanced data profile may be determined. The second enhanced data profile may be associated with the second plurality of content segments. The second enhanced data profile may comprise a representation of bits per unit time associated a second enhanced data stream. The second enhanced data stream may comprise the one or more content packets and one or more null packets.

At 740, a first information file may be generated. The first information file may comprise one or more null packet identifiers and/or null packet timing information associated with a first plurality of null packets inserted into the data stream associated with the first plurality of content segments.

At 750, a second information file may be generated. The second information file may comprise one or more null packet identifiers and/or null packet timing information associated with a second plurality of null packets inserted to the data stream associated with the second plurality of content segments of the content.

At 760, the first information file may be sent to the media device. The first information file may be sent to the media device before the first plurality of content segments. The first information file may be sent to the media device after the first plurality of content segments. The first information may be sent to the media device before sending the first plurality of null packets.

At 770, the second information file may be sent to the media device. The second information file may be sent to the media device before the second plurality of content segments. The second information file may be sent to the media device after the second plurality of content segments. The second information may be sent to the media device before sending the first plurality of null packets.

The method may comprise sending the first plurality of content segments to the media device. The method may comprise sending the second plurality of content segments to the media device. The method may comprise sending the first plurality of null packets to the media device. The method may comprise sending the second plurality of null packets to the media device. Sending either or both of the first plurality of null packets and/or the second plurality of null packets to the media device may comprise inserting the first plurality of null packets and/or the second plurality of null packets into a data stream so as to obfuscate the first bitrate profile associated with the first plurality of content segments and/or obfuscate the second bitrate profile associated with the second plurality of content segments.

The method may comprise receiving second content (e.g., an advertisement). For example, the secondary content may be received after the first plurality of content segments and first plurality of null packets but before the second plurality of content segments and second plurality of null packets.

The method may comprise appending a random number of bytes to each transmitted segment. The method may comprise a CDN generating a random number following some statistical distribution fitting natural video. For example, this number can be generated by the CDN edge as a part of processing an incoming HTTP GET request, or can be generated by the client and passed to the CDN (e.g., using a URL query parameter). As a response, the CDN may add fillers (e.g., filler NAL units, NULL packets (for MPEG-2 TS), ‘free’ ISO-BMFF boxes) to the requested segment.

In case of video on demand sessions, it is possible to achieve a similar effect without an additional bandwidth overhead. For example, the method may comprise the client requesting a random number of bytes from other (sub) segments or full subsegments, either from the same type of content (e.g., video) or from a different type (e.g., audio). The randomization may be determined by the CDN edge or requested by the client.

The method may comprise filling the client buffer to some high watermark and causing the media device to start requesting segments or byte ranges of a segment at randomized times so as to introduce random long pauses in requests and request bursts.

The method may comprise indicating that all media traffic is incremental (from the HTTP/3 priority definition standpoint), in which case packets with responses for video and audio segment requests may be transmitted in an interleaved manner.

The method may comprise receiving, from a media device, a request for content. The method may comprise sending, to the media device, based on the request, the content, supplemental content, and one or more information files, wherein the information file are configured to cause the media device to identify the supplemental content.

The method may comprise determining a bit profile associated with content. The method may comprise determining, based on the bit profile, one or more bit peaks. The method may comprise determining, based on the one or more bit peaks, one or more bit troughs. The method may comprise determining, based on the one or more bit peaks and the one or more bit troughs, an enhanced bit profile. The method may comprise generating, based on the enhanced bit profile, supplemental content and an information file associated with the content. The method may comprise sending, to a media device, the content, the supplemental content, and the information file.

The method may comprise receiving, from a content source, based on a request for content from a media device, content. The method may comprise determining, based on the content, a bit profile associated with the content. The method may comprise determining, based on the bit profile associated with the content, an enhanced bit profile associated with supplemental content and an information file associated with the supplemental content. The method may comprise sending, to the media device, based on the enhanced bit profile, the content, the supplemental content, and the information file.

The method may comprise sending, by a media device, a request for content. The method may comprise receiving, from a computing device, based on the request, the content, supplemental content, and an information file, wherein the information file is configured to cause the media device to identify the supplemental content.

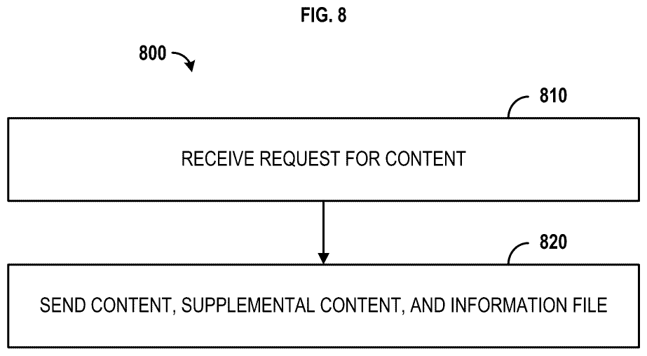

FIG. 8 shows an example method 800. The method may be carried out by any one or more devices as described herein. For example, at 810, a request for content may be received. The request for content may be received by a computing device (e.g., a content device such as a content server). The request for content may be sent from a media device. The request for content may comprise one or more identifiers associated with the content and/or one or more identifiers associated with the media device.

At 820, one or more packets of the content and one or more packets of supplemental content may be sent to the media device. For example, the one or more packets of supplemental content may be interspersed within (e.g., between) the one or more packets of content. The one or more packets of supplemental content may be interspersed within the content based on a data profile associated with the content. For example, the data profile associated with the content may indicate one or more data peaks. For example, the one or more packets of supplemental content may be interspersed within the content at the one or more data peaks.

At 830, an information file may be sent to the media device. For example, the information file may indicate one or more processing actions to be taken with respect to the content and/or the supplemental content. For example, the information file may comprise one or more storage actions associated with the content and/or supplemental content and/or one or more output actions associated with the content and/or supplemental content. For example, the information file may be configured to cause the media device to selectively store the content and/or the supplemental content. For example, the information file may be configured to cause the media device to selectively output the content and/or the supplemental content.

The method may comprise determining, based on a random number and a bitrate profile associated with the content, an amount of the supplemental content to send to the media device. The method may comprise determining, based on a variable bitrate encoding scheme, one or more bitrate peaks. The method may comprise generating, via one or more null packets, one or more bitrate troughs. For example, the one or more bitrate troughs may be generated by inserting one or more null packets into the stream at the time associated with the one or more bitrate peaks.

The method may comprise determining a bit profile associated with content. The method may comprise determining, based on the bit profile, one or more bit peaks. The method may comprise determining, based on the one or more bit peaks, one or more bit troughs. The method may comprise determining, based on the one or more bit peaks and the one or more bit troughs, an enhanced bit profile. The method may comprise generating, based on the enhanced bit profile, supplemental content and an information file associated with the content. The method may comprise sending, to a media device, the content, the supplemental content, and the information file.

The method may comprise receiving, from a content source, based on a request for content from a media device, content. The method may comprise determining, based on the content, a bit profile associated with the content. The method may comprise determining, based on the bit profile associated with the content, an enhanced bit profile associated with supplemental content and an information file associated with the supplemental content. The method may comprise sending, to the media device, based on the enhanced bit profile, the content, the supplemental content, and the information file.

The method may comprise sending, by a media device, a request for content. The method may comprise receiving, from a computing device, based on the request, the content, supplemental content, and an information file, wherein the information file is configured to cause the media device to identify the supplemental content.

The method may comprise determining, based on a request for content, a first bit profile associated with a first plurality of content segments of the content and a second bit profile associated with a second plurality of content segments of the content. The method may comprise determining, based on the first bit profile associated with the first plurality of content segments, a first enhanced bit profile associated with the first plurality of content segments. The method may comprise determining, based on the second bit profile associated with the second plurality of content segments, a second enhanced bit profile associated with the second plurality of content segments. The method may comprise generating, based on the first enhanced bit profile associated with the first plurality of content segments, a first information file. The method may comprise generating, based on the second enhanced bit profile associated with the second plurality of content segments, a second information file. The method may comprise sending, to the media device, the first information file. The method may comprise sending, to the media device the second information file.

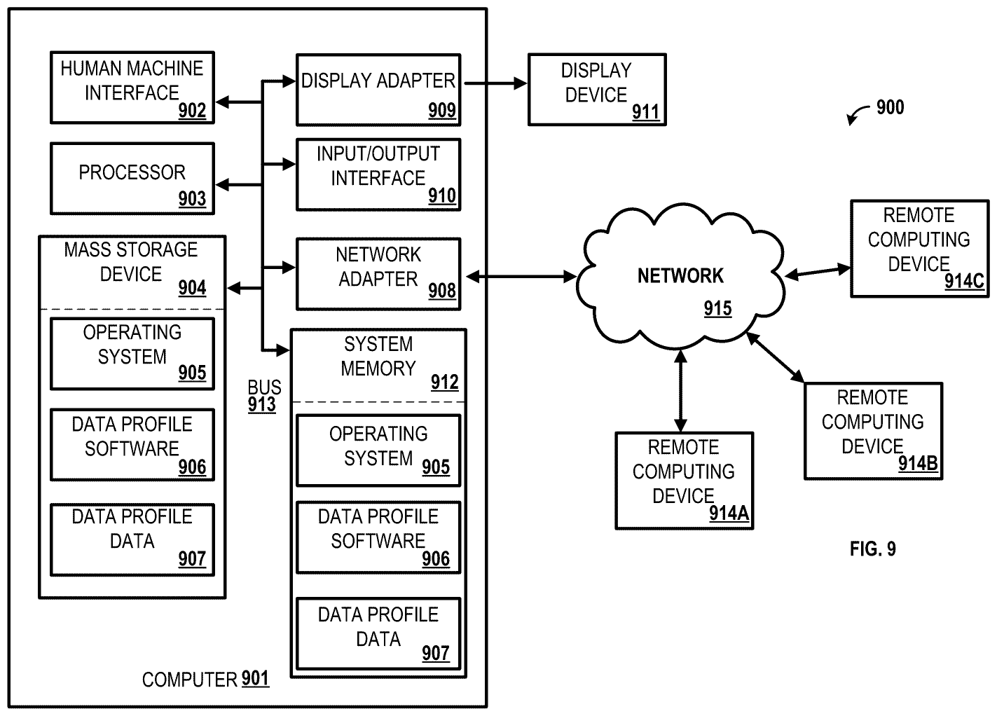

The above described disclosure may be implemented on a computer 901 as illustrated in FIG. 9 and described below. By way of example, computing device 110 of FIG. 1 can be a computer as illustrated in FIG. 9. Similarly, user device 130 may be a computer as illustrated in FIG. 9. FIG. 9 is a block diagram illustrating an example operating environment for performing the disclosed methods. This example operating environment is only an example of an operating environment and is not intended to suggest any limitation as to the scope of use or functionality of operating environment architecture. Neither should the operating environment be interpreted as having any dependency or requirement relating to any one or combination of components illustrated in the example operating environment.

The present disclosure can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Examples comprise set top boxes, programmable consumer electronics, network PCs, minicomputers, mainframe computers, distributed computing environments that comprise any of the above systems or devices, and the like.

The processing of the disclosed can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computer 901. The components of the computer 901 can comprise, but are not limited to, one or more processors 903, a system memory 912, and a system bus 913 that couples various system components including the one or more processors 903 to the system memory 912. 903. The system can utilize parallel computing.

The system bus 913 represents one or more of several possible types of bus structures, including a memory bus or memory controller, a peripheral bus, an accelerated graphics port, or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 913, and all buses specified in this description can also be implemented over a wired or wireless network connection and each of the subsystems, including the one or more processors 903, a mass storage device 904, an operating system 905, storage software 906, storage data 907, a network adapter 908, the system memory 912, an Input/Output Interface 910, a display adapter 909, a display device 911, and a human machine interface 902, can be contained within one or more remote computing devices 914A, 914B, 914C at physically separate locations, connected through buses of this form, in effect implementing a fully distributed system.

The computer 901 typically comprises a variety of computer readable media. Example readable media can be any available media that is accessible by the computer 901 and comprises, for example and not meant to be limiting, both volatile and non-volatile media, removable and non-removable media. The system memory 912 comprises computer readable media in the form of volatile memory, such as random access memory (RAM), and/or non-volatile memory, such as read only memory (ROM). The system memory 912 typically contains data such as the storage data 907 and/or program modules such as the operating system 905 and the storage software 906 that are immediately accessible to and/or are presently operated on by the one or more processors 903.

The computer 901 can also comprise other removable/non-removable, volatile/non-volatile computer storage media. By way of example, FIG. 9 illustrates the mass storage device 904 which can facilitate non-volatile storage of computer code, computer readable instructions, data structures, program modules, and other data for the computer 901. For example and not meant to be limiting, the mass storage device 904 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 904, including by way of example, the operating system 905 and the storage software 906. Each of the operating system 905 and the storage software 906 (or some combination thereof) can comprise elements of the programming and the storage software 906. The storage data 907 can also be stored on the mass storage device 904. The storage data 907 can be stored in any of one or more databases known in the art. Examples of such databases comprise, DB2®, Microsoft® Access, Microsoft® SQL Server, Oracle®, MySQL, PostgreSQL, and the like. The databases can be centralized or distributed across multiple systems.

The user or device can enter commands and information into the computer 901 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the one or more processors 903 via the human machine interface 902 that is coupled to the system bus 913, but can be connected by other interface and bus structures, such as a parallel port, game port, an IEEE 1394 Port (also known as a Firewire port), a serial port, or a universal serial bus (USB).

The display device 911 can also be connected to the system bus 913 via an interface, such as the display adapter 909. It is contemplated that the computer 901 can have more than one display adapter 909 and the computer 901 can have more than one display device 911. For example, the display device 911 can be a monitor, an LCD (Liquid Crystal Display), or a projector. In addition to the display device 911, other output peripheral devices can comprise components such as speakers (not shown) and a printer (not shown) which can be connected to the computer 901 via the Input/Output Interface 910. Any step and/or result of the methods can be output in any form to an output device. Such output can be any form of visual representation, including, but not limited to, textual, graphical, animation, audio, tactile, and the like. The display device 911 and computer 901 can be part of one device, or separate devices.

The computer 901 can operate in a networked environment using logical connections to one or more remote computing devices 914A, 914B, 914C. By way of example, a remote computing device can be a gaming system, personal computer, portable computer, smartphone, a server, a router, a network computer, a peer device or other common network node, and so on. Logical connections between the computer 901 and a remote computing device 914A, 914B, 914C can be made via a network 915, such as a local area network (LAN) and/or a general wide area network (WAN). Such network connections can be through the network adapter 908. The network adapter 908 can be implemented in both wired and wireless environments. Such networking environments are conventional and commonplace in dwellings, offices, enterprise-wide computer networks, intranets, and the Internet.

For purposes of illustration, application programs and other executable program components such as the operating system 905 are illustrated herein as discrete blocks, although it is recognized that such programs and components reside at various times in different storage components of the computing device 901, and are executed by the one or more processors 903 of the computer. An implementation of the selective storage software 906 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Example computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The disclosure can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

While the disclosure has been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as an example only, with a true scope and spirit being indicated by the following claims.

1. A method comprising:
receiving, from a media device, a request for content;
sending, to the media device:
the content,
supplemental content that is based on a data profile associated with the content, wherein the supplemental content is configured to obfuscate the data profile, and
an information file configured to cause the media device to process the content and supplemental content.

2. The method of claim 1, further comprising causing the media device to process one or more packets of content and one or more packets of supplemental content according to the information file.

3. The method of claim 2, wherein causing the media device to process the one or more packets of content and the one or more packets of supplemental content according to the information file comprises causing the media device to:
output the one or more packets of content; and
not output the one or more packets of supplemental content.

4. The method of claim 1, wherein the supplemental content comprises one or more null packets and wherein the media device is configured to ignore, based on the information file, the one or more null packets.

5. The method of claim 1, wherein sending the supplemental content and the information file comprises:
determining, based on the content, a bitrate profile associated with the content; and
determining, based on the bitrate profile, an enhanced bitrate profile, wherein the enhanced bitrate profile is configured to obfuscate the bitrate profile associated with the content.

6. The method of claim 5, wherein determining the enhanced bitrate profile comprises:
determining a bitrate profile associated with the content;
determining, based on the bitrate profile associated with the content, an amount of supplemental content; and
determining, based on a bitrate profile associated with the content, timing information associated with the supplemental content.

7. The method of claim 1, further comprising determining, based on a random number and a bitrate profile associated with the content, an amount of the supplemental content to send to the media device.

8. A method comprising:
determining a data profile associated with content;
determining, based on the data profile, one or more data peaks;
determining, based on the one or more data peaks, one or more data troughs;
determining, based on the one or more data peaks and the one or more data troughs, an enhanced data profile;
generating, based on the enhanced data profile, supplemental content and an information file associated with the content; and
sending, to a media device, the content, the supplemental content, and the information file.

9. The method of claim 8, wherein the data profile comprises a bitrate profile, wherein the one or more data troughs comprise one or more bitrate troughs, and wherein the information file is configured to cause to the media device to ignore one or more null packets.

10. The method of claim 8, wherein determining the enhanced data profile comprises:
determining, based on a variable bitrate encoding scheme, the one or more data peaks; and
generating, via one or more null packets, the one or more data troughs.

11. The method of claim 8, wherein the information file comprises one or more null packet identifiers and null packet timing information.

12. The method of claim 8, further comprising receiving, from the media device, a request for both the content and supplemental content, wherein the request is configured to cause a computing device to insert, based on the request for the content, a random amount of supplemental content into a data stream associated with the content.

13. The method of claim 8, further comprising determining, based on the content, an amount of supplemental content to insert into a data stream comprising the content.

14. The method of claim 8, further comprising inserting, into a data stream comprising the content, one or more null packets.

15. A method comprising:
receiving, from a content source, based on a request for content from a media device, content;
determining, based on the content, a data profile associated with the content;
determining, based on the data profile associated with the content, an enhanced data profile associated with supplemental content and an information file associated with the supplemental content; and
sending, to the media device, the content, the information file, and, based on the enhanced data profile, the supplemental content.

16. The method of claim 15, wherein the supplemental content comprises one or more null packets and wherein the enhanced data profile is configured to obfuscate the data profile associated with the content.

17. The method of claim 15, wherein the information file is configured to cause the media device to ignore the supplemental content.

18. The method of claim 15, wherein receiving the supplemental content comprises receiving the supplemental content in a data stream comprising the content.

19. The method of claim 15, wherein determining the supplemental content comprises determining a difference between the data profile and a constant bitrate.

20. The method of claim 15, further comprising:
determining a difference between the data profile and a constant bitrate; and
determining, based on the different, an amount of supplemental content to send to the media device.
